(19) United States
(12) Patent Application Publication
(10) Pub. No.: US 2008/0031146 A1
(43) Pub. Date: Feb. 7, 2008

(54) METHOD AND APPARATUS FOR MEASURING LABEL SWITCH PATH PERFORMANCE PARAMETERS USING PERFORMANCE MONITORING OPERATION AND MANAGEMENT PACKET IN MULTI-PROTOCOL LABEL SWITCHING NETWORK

(76) Inventors: Dong Yong KWAK, Daejeon-city (KR); Hae Sook KIM, Daejeon-city (KR); Jong Rak KIM, Daejeon-city (KR); Jeong Jong LEE, Daejeon-city (KR); Kyeong Ho LEE, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/778,869

(22) Filed: Jul. 17, 2007

(30) Foreign Application Priority Data
Aug. 3, 2006 (KR) 10-2006-0073261
Dec. 8, 2006 (KR) 10-2006-0125028

(51) Int. Cl. G06F 11/00

(52) U.S. Cl. 370/250; 370/241.1

(57) ABSTRACT

Provided is a method and apparatus for measuring performance parameters of a Label Switch Path (LSP) using an Operation & Maintenance (OAM) performance monitoring packet in a Multi-Protocol Label Switching (MPLS) network, and more particularly, a method and apparatus for measuring packet loss, packet transfer delay, and jitter of an LSP set between two Label Switch Routers (LSRs) using an MPLS OAM packet. Accordingly, the present invention can overcome the limitation that existing MPLS OAM technology is dedicated to only identify malfunction of an LSP, and by also adding parameters (packet loss ratio, packet transfer delay and jitter related to SLA to a payload of an MPLS OAM packet as new required fields, provides a performance measurement method capable of measuring SLA performance parameters based on the newly added fields.

### CROSS-REFERENCE TO RELATED PATENT APPLICATION

This application claims the benefit of Korean Patent Application No. 10-2006-0073261, filed on Aug. 3, 2006 and Korean Patent Application No. 10-2006-0125028, filed on Dec. 8, 2006, in the Korean Intellectual Property Office, the disclosures of which are incorporated herein in their entirety by reference.

### BACKGROUND OF THE INVENTION

1. Field of the Invention

The present invention relates to a method and apparatus for measuring performance parameters of a Label Switch Path (LSP) using a performance monitoring Operation & Maintenance (OAM) packet in a Multi-Protocol Label Switching (MPLS) network, and more particularly, to a method and apparatus for measuring a packet loss ratio, a packet transfer delay, and jitter of an LSP set between two Label Switch Routers (LSRs) using an MPLS OAM packet.

2. Description of the Related Art

Recently, typical line-based applications, such as voice and video, tend to have been serviced in packet switch networks. However, these services can guarantee Quality of Service (QoS) based only on rigid control for forwarding, routing, and switching of Internet Protocol (IP) packets. Thus, Multi-Protocol Label Switching (MPLS) is becoming known as a core technology for providing control capabilities to IP packet networks. MPLS is a layer 3 label switching technique for packet transmission of a cut and through method being standardized by the Internet Engineering Task Force (IETF), and realizes a high rate of packet transmission by separating packet transmission processing and calculation processing in an access type communication network such as Asynchronous Transfer Mode (ATM).

In addition, MPLS is based on the use of a terminated connector between nodes, wherein a connection set between nodes is related to path information of a network layer. The connection can be identified by a label or a tag, and when a switch receives a packet to which a label is attached, it transmits the packet based on the label. That is, once a label is assigned according to path information, transmission processing of a packet is independent of path calculation processing. If the path information is modified, a new label is assigned. Examples of techniques related to this are tag switching, of Cisco Systems, and ARIS of IBM.

An International Telecommunication Union-Telecommunication Standardization Sector (ITU-T) MPLS OAM standard recommendation Y.1731 defines only an OAM function of identifying obstacles in LSP with respect to an MPLS OAM packet. Thus, the existing OAM function has the limitation that Service Level Agreement (SLA) performance parameters, such as the packet loss ratio, packet transfer delay, and jitter, which are measures used to guarantee the quality of an LSP, cannot be measured, wherein the LSP is a path set between two Label Switch Routers (LSRs).

### SUMMARY OF THE INVENTION

The present invention provides a structure and a performance measuring method of a Multi-Protocol Label Switching (MPLS) Operation & Maintenance (OAM) performance monitoring packet, whereby packet loss, packet transfer delay, and jitter, which indicate measures used to guarantee the quality of a Label Switch Path (LSP) set between Label Switch Routers (LSRs), can be measured using an MPLS OAM packet. MPLS OAM performance monitoring packet include a frequency field indicating the frequency of generation of performance monitoring packets, a time stamp field indicating the time when the performance monitoring packet is transmitted, and a transmission counter field storing a transmission counter value indicating the number of data packets via an LSP designated. When the MPLS OAM performance monitoring packet is transmitted, a sink LSR can receive the MPLS OAM packet, calculate packet loss using the transmission counter field, and calculate packet transfer delay and jitter using the time stamp field. Thus, Service Level Agreement (SLA) performance parameters indicating the measures used to guarantee the quality of the LSP can be calculated.

According to an aspect of the present invention, there is provided a method of generating a packet in order to monitor the performance of a Label Switch Path (LSP) set between two Label Switch Routers (LSRs) in a Multi-Protocol Label Switching (MPLS) network, the method comprising: selecting Service Level Agreement (SLA) performance parameters of an LSP to be measured using a performance monitoring packet; if the selected SLA parameter is related to packet loss of transmitted data, inserting a transmission counter field storing the number of data packets transmitted via an LSP designated when the performance monitoring packet is transmitted, into the performance monitoring packet; and if the selected SLA parameter is related to delay time or jitter occurring when the data packets are transmitted, inserting a time stamp field storing the time when the performance monitoring packet is transmitted, into the performance monitoring packet.

According to another aspect of the present invention, there is provided a method of processing a performance monitoring packet in order to measure the performance of a Label Switch Path (LSP) set between two Label Switch Routers (LSRs) in a Multi-Protocol Label Switching (MPLS) network, the method comprising: a source LSR transmitting a performance monitoring packet comprising at least one of a transmission counter field storing the number of data packets transmitted via a designated LSP, a time stamp field storing the time when the performance monitoring packet is transmitted and a frequency field storing the frequency of transmission of performance monitoring packets to a sink LSR together with the data packets; the sink LSR receiving and classifying the performance monitoring packet and the data packets; if the transmission counter field exists in the performance monitoring packet, calculating packet loss based on the value of the transmission counter field and the number of the received data packets; and if the time stamp field exists in the performance monitoring packet, calculating packet transfer delay time by subtracting the time when the performance monitoring packet is received from the value of the time stamp field.

According to another aspect of the present invention, there is provided an apparatus for processing packets in order to measure the performance of a Label Switch Path (LSP) set between two Label Switch Routers (LSRs) in a Multi-Protocol Label Switching (MPLS) network, the apparatus comprising: a packet transmission processing unit transmitting a performance monitoring packet comprising at least one of a transmission counter field storing the number of data packets transmitted via a designated LSP, a time stamp field storing the time when the performance monitoring packet is transmitted, and a frequency field storing the frequency of transmission of performance monitoring packets, together with the data packets; and a packet reception processing unit receiving the performance monitoring packet and the data packets, and if the transmission counter field exists in the performance monitoring packet, calculating packet loss based on the value of the transmission counter field and the number of the received data packets, and if the time stamp field exists in the performance monitoring packet, calculating packet transfer delay time by subtracting the time when the performance monitoring packet is received from the value of the time stamp field.

According to another aspect of the present invention, there is provided an interface apparatus for processing Operation & Maintenance (OAM) packets regarding a Label Switch Path (LSP) set in a Multi-Protocol Label Switching (MPLS) network, the interface apparatus comprising: a packet transceiver transmitting a plurality of data packets or OAM packets by converting an optical signal to an electrical signal; a frame multiplexer/demultiplexer multiplexing the plurality of data packets or OAM packets, or demultiplexing multiplexed packets; a network processor unit calculating packet loss or packet transfer delay time, based on a transmission counter field storing the number of data packets transmitted via a designated LSP or a time stamp field storing the time when an OAM packet is transmitted if a packet received from the frame multiplexer/demultiplexer is an OAM packet; and generating OAM packet, which comprise the transmission counter field and/or the time stamp field, to be transmitted to the network, and a switch fabric interface unit transmitting a data packet to the network if a packet received from the frame multiplexer/demultiplexer is a data packet.

According to another aspect of the present invention, there is provided a recording medium for recording packet frames in order to measure the performance of a Label Switch Path (LSP) set between two Label Switch Routers (LSRs) in a Multi-Protocol Label Switching (MPLS) network, the recording medium comprising: a transmission counter field storing the number of data packets transmitted via a designated LSP in order to calculate loss of transmitted data packets; and a time stamp field storing the time when a performance monitoring packet is transmitted in order to calculate delay time or jitter in transmission of the data packets.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates the structure of a Multi-Protocol Label Switching (MPLS) Operation & Maintenance (OAM) packet, which is a performance monitoring packet for a Label Switch Path (LSP), according to an embodiment of the present invention;

FIG. 2 is a block diagram describing the transmission of an OAM packet and the operation of an OAM packet transmitter and an OAM packet receiver according to an embodiment of the present invention;

FIG. 3 is a flowchart illustrating a method of generating a packet for performance monitoring of an LSP according to an embodiment of the present invention;

FIG. 4 is a flowchart illustrating a method used by a transmitter and a receiver to process a performance monitoring packet according to an embodiment of the present invention;

FIG. 5 is a flowchart illustrating a process of generating and transmitting an MPLS OAM packet according to an embodiment of the present invention;

FIG. 6 is a block diagram of a packet processing apparatus for generating, transmitting, and receiving performance monitoring packets according to an embodiment of the present invention;

FIG. 7 is a block diagram of a line interface apparatus for processing an MPLS OAM packet according to an embodiment of the present invention;

FIG. 8 is a flowchart illustrating a method used by the line interface apparatus illustrated in FIG. 7 to process an MPLS OAM packet according to an embodiment of the present invention; and

FIG. 9 illustrates the correlation between performance parameters and fields of an MPLS OAM packet according to an embodiment of the present invention.

### DETAILED DESCRIPTION OF THE INVENTION

The present invention will now be described in detail by explaining preferred embodiments of the invention with reference to the attached drawings.

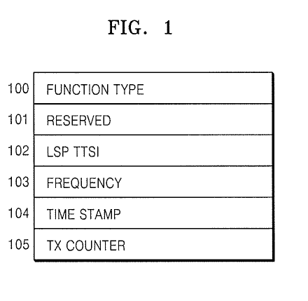

FIG. 1 illustrates the structure of a Multi-Protocol Label Switching (MPLS) Operation & Maintenance (OAM) packet, which is a performance monitoring packet for a Label Switch Path (LSP), according to an embodiment of the present invention.

The MPLS OAM performance monitoring packet of FIG. 1 achieves one purpose of the present invention. Referring to FIG. 1, the MPLS OAM packet includes a function type field 100 indicating an OAM function type, a reserved field 101 that is to be defined and used in the future, an LSP identifier (LSP TTSI) field 102 indicating the LSP of which performance is currently monitored, a frequency field 103 indicating a transmission period of a performance monitoring packet, a time stamp field 104 indicating the time when the performance monitoring packet is transmitted, and a transmission (Tx) counter field 105 storing a Tx counter value indicating the number of data packets via an LSP designated when a source Label Switch Router (LSR) transmits the performance monitoring packet.

The time stamp field 104 may be eight octet numbers, and the Tx counter field 105 may be four octet numbers.

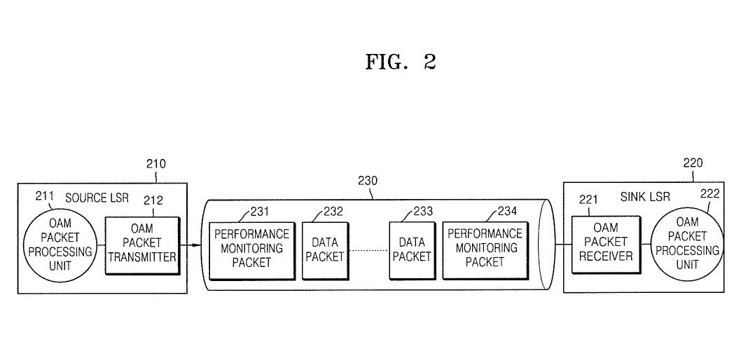

FIG. 2 is a block diagram describing the transmission of an OAM packet and the operation of an OAM packet transmitter and an OAM packet receiver according to an embodiment of the present invention.

Referring to FIG. 2, an OAM packet processing unit 211 of a source LSR 210 transmits a generation request of an OAM packet for performing performance monitoring, to an OAM packet transmitter 212 of the source LSR 210. The OAM packet transmitter 212 generates a performance monitoring OAM packet and transmits it to a sink LSR 220. The performance monitoring OAM packet includes the current time stored in a time stamp field, the frequency of generation of performance monitoring packets stored in a frequency field, and a transmission counter value of a designated LSP stored in a Tx counter field.

An OAM packet receiver 221 of the sink LSR 220 receives a packet 230 including performance monitoring OAM packets 231 and 234 and data packets 232 and 233, and outputs the packet 230 to an OAM packet processing unit 222 of the sink LSR 220. The OAM packet processing unit 222 calculates Service Level Agreement (SLA) performance parameter values, which indicate measures used to guarantee the quality of the LSP, by calculating a packet loss ratio using the Tx counter field in the packet 230 and calculating a packet delay and jitter using the time stamp field.

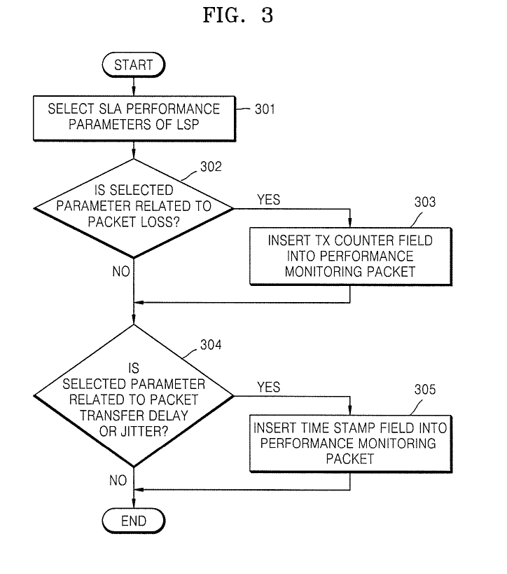

FIG. 3 is a flowchart illustrating a method of generating a packet for performance monitoring of an LSP according to an embodiment of the present invention.

Referring to FIG. 3, SLA performance parameters of a target LSP of a performance monitoring packet are determined in operation 301. If it is determined in operation 302 that the SLA performance parameters are related to packet loss of transmission data, a Tx counter field storing the number of data packets transmitted via an LSP designated when the performance monitoring packet is transmitted is included in the performance monitoring packet in operation 303. If it is determined in operation 304 that the SLA performance parameters are related to a delay time or jitter occurring when the data packets are transmitted, a time stamp field storing a transmission time of the performance monitoring packet is included in the performance monitoring packet in operation 305. Finally, the performance monitoring packet is generated. Here, the performance monitoring packet is an OAM packet or a separate packet included in the OAM packet.

The performance monitoring packet may further include a frequency field indicating the transmission frequency of the performance monitoring packet, a function type field indicating a unique function type of the performance monitoring packet, and/or an LSP identifier field indicating the LSP of which performance monitoring is requested.

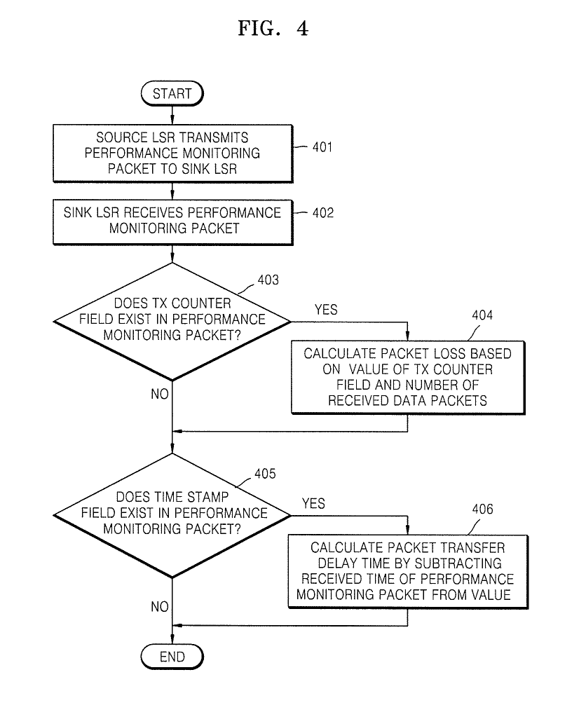

FIG. 4 is a flowchart illustrating a method used by a transmitter and a receiver to process an LSP performance monitoring packet according to an embodiment of the present invention.

Referring to FIG. 4, a source LSR transmits a performance monitoring packet, including at least one of a Tx counter field, a time stamp field, and a frequency field, to a sink LSR together with data packets, in operation 401. The sink LSR receives the performance monitoring packet and the data packets and classifies the performance monitoring packet and the data packets in operation 402. If the Tx counter field exists in the performance monitoring packet in operation 403, the sink LSR calculates a packet loss based on the value of the Tx counter field and the number of data packets in operation 404. If the time stamp field exists in the performance monitoring packet in operation 405, the sink LSR calculates a packet transfer delay time by subtracting the received time of the performance monitoring packet from the value of the time stamp field, in operation 406. Here, the performance monitoring packet is an OAM packet or a separate packet included in the OAM packet.

The performance monitoring packet is transmitted when a performance monitoring start request is input from the outside or when a time set in a timer of the frequency field has elapsed. Thus, when the source LSR transmits the performance monitoring packet, it resets the timer of the frequency field for next transmission. However, if a performance monitoring end request is input from the outside, the timer may be terminated so that no more performance monitoring packets are transmitted. The packet loss is calculated by subtracting the difference (C−D) between a packet counter value (C) after the sink LSR receives the data packets and a packet counter value (D) before the sink LSR receives the data packets, from the difference (A−B) between the value (A) of the Tx counter field and the packet counter value (B) before the source LSR transmits the data packets. After the calculation of the packet loss, in order to prepare for transmission of the next performance monitoring packet, the value (A) of the Tx counter field is stored as a packet counter value of the source LSR, and the packet counter value (C) after the sink LSR receives the data packets is stored as a packet counter value of the sink LSR.

In order to measure the packet transfer delay time, clock synchronization is needed between the source LSR and the sink LSR. The delay measurement method suggested by the ITU-T MPLS OAM standard recommendation Y.1731 cannot be applied to an MPLS network without clock synchronization, due to the one-directional nature of LSPs. Packet jitter can be calculated using a method of calculating a transfer delay time deviation based on the packet transfer delay time.

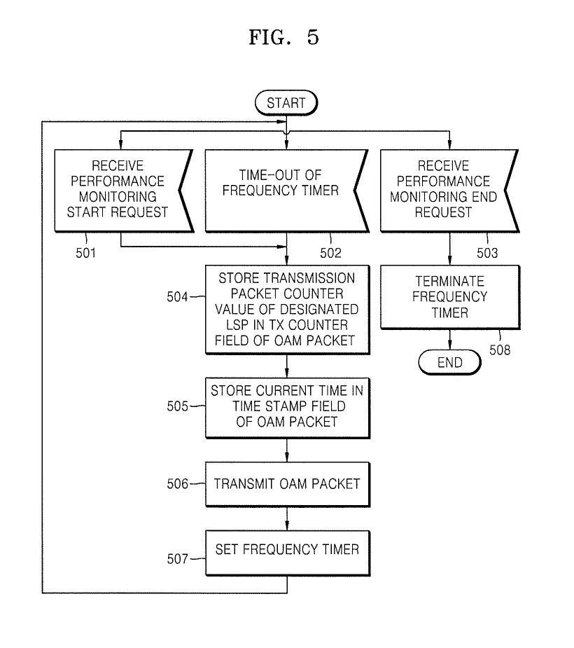

FIG. 5 is a flowchart illustrating a process of generating and transmitting an MPLS OAM packet according to an embodiment of the present invention.

Referring to FIG. 5, the OAM packet processing unit 211 receives a performance monitoring start request from a network control platform in operation 501. The OAM packet transmitter 212 stores a transmission packet counter value of a designated LSP in a Tx counter field of a performance monitoring OAM packet in operation 504, stores the current time in a time stamp field of the performance monitoring OAM packet in operation 505, and transmits the performance monitoring OAM packet in operation 506.

The OAM packet processing unit 211 sets a frequency timer of the next performance monitoring packet in operation 507. If a time-out call of the frequency timer occurs in operation 502, operations 504 through 507 are repeated. However, if a performance monitoring end request is received in operation 503, the frequency timer is terminated in operation 508, and the process ends.

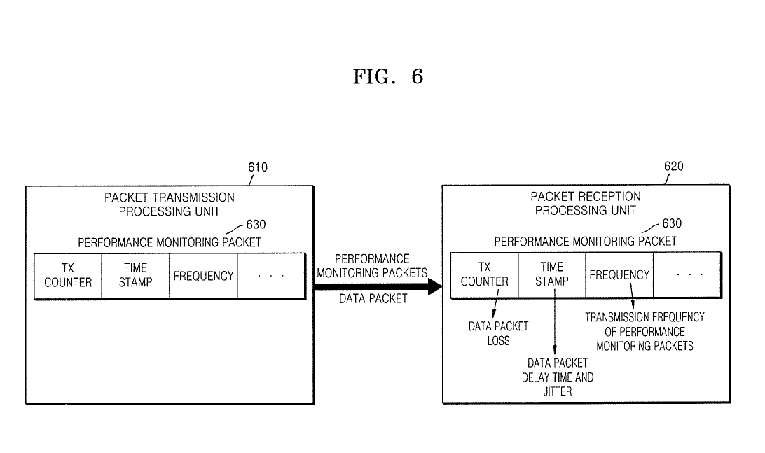

FIG. 6 is a block diagram of a packet processing apparatus for generating, transmitting, and receiving performance monitoring packets according to an embodiment of the present invention.

Referring to FIG. 6, the packet processing apparatus includes a packet transmission processing unit 610 and a packet reception processing unit 620. The packet transmission processing unit 610 transmits a performance monitoring packet 630 including at least one of a transmission counter field storing the number of data packets transmitted via a designated LSP, a time stamp field storing the time when the performance monitoring packer is transmitted, and a frequency field storing the frequency of performance monitoring packets, together with the data packets. The packet reception processing unit 620 receives the performance monitoring packet 630 and the data packets, calculates packet loss based on the value of the transmission counter field and the number of received data packets, if the transmission counter field exists in the performance monitoring packet 630, and calculates a packet transfer delay time by subtracting the received time of the performance monitoring packet 630 from the value of the time stamp field, if the time stamp field exists in the performance monitoring packet 630. The performance monitoring packet 630 is an OAM packet or a separate packet included in the OAM packet.

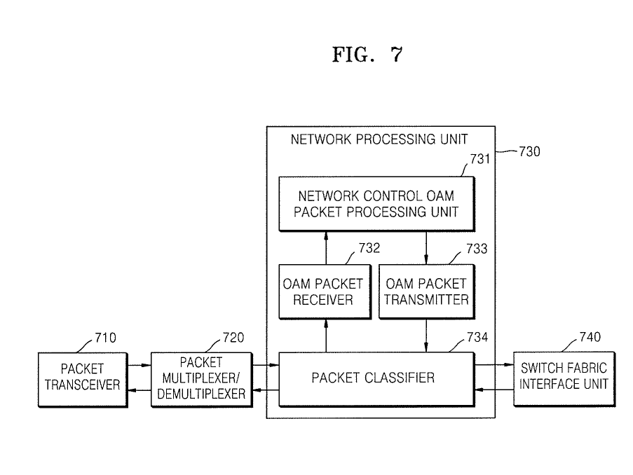

FIG. 7 is a block diagram of a line interface apparatus for processing an MPLS OAM packet according to an embodiment of the present invention. FIG. 7 illustrates the internal structure of the line interface apparatus for an MPLS OAM function.

Referring to FIG. 7, the line interface apparatus includes a packet transceiver 710, a frame multiplexer/demultiplexer 720, a network processor unit 730, and a switch fabric interface unit 740. The packet transceiver 710 transmits a plurality of data packets or OAM packets by converting an optical signal to an electrical signal. The frame multiplexer/demultiplexer 720 multiplexes the plurality of data packets or OAM packets input from the packet transceiver 710 and outputs the multiplexed packets to the network processor unit 730, or demultiplexes a plurality of packets processed by the network processor unit 730 and outputs the plurality of packets to the packet transceiver 710. The network processor unit 730 determines whether input packets are data packets or OAM packets and processes the input packets based on the result. The switch fabric interface unit 740 transmits data packets to another line interface apparatus based on forwarding information.

The network processor unit 730 includes a packet classifier 734, an OAM packet receiver 732 performing OAM processing when an input packet is determined to be an MPLS OAM packet by the packet classifier 734, a network control OAM packet processing unit 731 requesting transmission of an OAM packet with information required for an OAM packet assembly in order to transmit the OAM packet, and an OAM packet transmitter 733 generating and transmitting an OAM packet. The OAM packet transmitter 733 resets a timer in a frequency field when the OAM packet transmitter 733 transmits an OAM packet to the switch fabric interface unit 740.

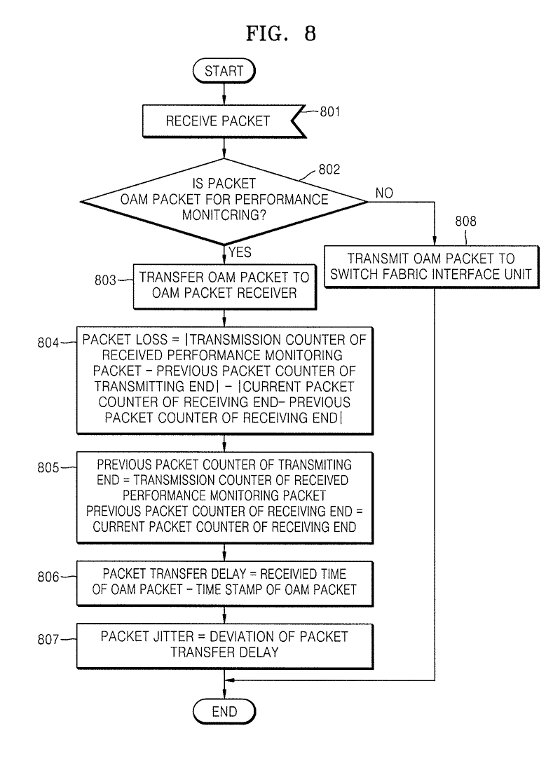

FIG. 8 is a flowchart illustrating a method used by the line interface unit illustrated in FIG. 7 to process a received MPLS OAM packet according to an embodiment of the present invention. This method is performed by the network processor unit 730 of the line interface unit illustrated in FIG. 7.

Referring to FIG. 8, the packet classifier 734 receives a packet in operation 801. The packet classifier 734 determines in operation 802 whether the received packet is a data packet or a performance monitoring OAM packet. If it is determined in operation 802 that the received packet is a data packet, the packet classifier 734 transfers the data packet to the switch fabric interface unit 740 in operation 808, so that the data packet is transmitted to the next node (terminal). When the received packet is transmitted to the switch fabric interface unit 740, a timer in a frequency field is reset.

If it is determined in operation 802 that the received packet is an MPLS performance monitoring OAM packet, the packet classifier 734 transfers the MPLS performance monitoring OAM packet to the OAM packet receiver 732 in operation 803. The OAM packet receiver 732 calculates packet loss using the equation below, in operation 804.
Packet loss=|transmission counter of received performance monitoring packet−previous packet counter of a transmitting end|−|current packet counter of a receiving end−previous packet counter of the receiving end|

In operation 805, a transmission counter of the received packet is stored in the previous transmission counter, and the current packet counter of the receiving end is stored in the previous packet counter of the receiving end.

In more detail, the OAM packet receiver 732 calculates the packet loss by subtracting the difference (C−D) between the packet counter value (C) after the receiving end receives the data packet and the packet counter value (D) before the receiving end receives the data packet, from the difference (A−B) between the value (A) of a Tx counter field and the packet counter value (B) before a transmitted end transmits the data packet. After the calculation of the packet loss, in order to be able to calculate the packet loss of subsequent packets, the value (A) of the Tx counter field is stored as the packet counter value of the transmitting end, and the packet counter value (C) after the receiving end receives the data packet is stored as the packet counter value of the receiving end.

The OAM packet receiver 732 calculates a packet transfer delay using the equation below, in operation 806.
Packet transfer delay=received time of performance monitoring OAM packet−time stamp of the performance monitoring OAM packet.

The OAM packet receiver 732 calculates packet jitter by calculating the deviation of the packet transfer delay in operation 807.

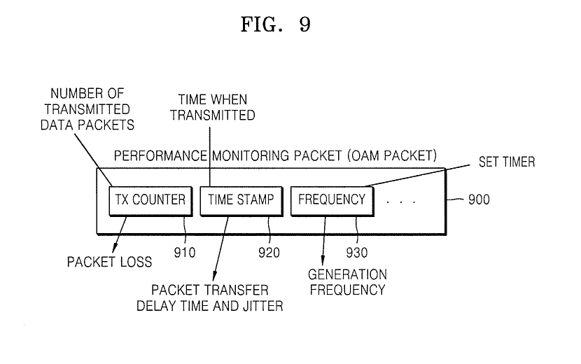

FIG. 9 illustrates the correlation between performance parameters and fields of an MPLS OAM packet according to an embodiment of the present invention.

Referring to FIG. 9, an OAM packet 900, which is a performance monitoring packet, includes a transmission counter field 910 storing the number of data packets transmitted via a designated LSP, to calculate loss of data packets, a time stamp field 920 storing the transmission time of the performance monitoring packet to calculate delay time or jitter in transmission of the data packets, and a frequency field 930 storing a transmission frequency of the performance monitoring packet using a set timer.

A packet loss ratio can be calculated using the value of the transmission counter field 910, and a packet transfer delay time and packet jitter can be calculated using the time stamp field 920. The performance of an LSP can be measured by periodically transmitting a performance monitoring packet using the frequency field 930.

The invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, code, and code segments for accomplishing the present invention can be easily construed by programmers skilled in the art to which the present invention pertains.

As described above, according to the present invention, a frequency field indicating the frequency of generation of performance monitoring packets, a time stamp field indicating the transmission time of the performance monitoring packet, and a transmission counter field storing a transmission counter value indicating the number of data packets of an LSP designated when a source LSR transmits the performance monitoring packet to a sink LSR are added to an MPLS OAM packet, and the source LSR transmits the MPLS OAM packet to the sink LSR, allowing the sink LSR to calculate SLA performance parameters indicating the measures used to guarantee LSP quality, by receiving the MPLS OAM packet, calculating a packet loss ratio using the transmission counter field in the MPLS OAM packet, and calculating a packet transfer delay and jitter using the time stamp field.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A method of generating a packet in order to monitor the performance of a Label Switch Path (LSP) set between two Label Switch Routers (LSRs) in a Multi-Protocol Label Switching (MPLS) network, the method comprising:
selecting Service Level Agreement (SLA) performance parameters of an LSP to be measured using a performance monitoring packet;
if the selected SLA parameter is related to packet loss of transmitted data, inserting a transmission counter field storing the number of data packets transmitted via an LSP designated when the performance monitoring packet is transmitted, into the performance monitoring packet; and
if the selected SLA parameter is related to delay time or jitter occurring when the data packets are transmitted, inserting a time stamp field storing the time when the performance monitoring packet is transmitted, into the performance monitoring packet.

2. The method of claim 1, further comprising inserting a frequency field indicating the frequency of transmission of performance monitoring packets, into the performance monitoring packet.

3. The method of claim 2, further comprising inserting at least one of a function type field indicating a function type of the performance monitoring packet and an LSP identifier field indicating an LSP of which performance monitoring is requested, into the performance monitoring packet.

4. The method of claim 1, wherein the performance monitoring packet is an OAM packet or a separate packet comprised in the OAM packet.

5. A method of processing a performance monitoring packet in order to measure the performance of a Label Switch Path (LSP) set between two Label Switch Routers (LSRs) in a Multi-Protocol Label Switching (MPLS) network, the method comprising:
(a) a source LSR transmitting a performance monitoring packet comprising at least one of a transmission counter field storing the number of data packets transmitted via a designated LSP, a time stamp field storing the time when the performance monitoring packet is transmitted, and a frequency field storing the frequency of transmission of the performance monitoring packet, to a sink LSR together with the data packets;
(b) the sink LSR receiving and classifying the performance monitoring packet and the data packets;
(c) if the transmission counter field exists in the performance monitoring packet, calculating packet loss based on the value of the transmission counter field and the number of the received data packets; and
(d) if the time stamp field exists in the performance monitoring packet, calculating packet transfer delay time by subtracting the time when the performance monitoring packet is received from the value of the time stamp field.

6. The method of claim 5, wherein (a) comprises transmitting the performance monitoring packet to the sink LSR when a performance monitoring start request is input from the outside or when a time set in a timer of the frequency field has elapsed.

7. The method of claim 5, wherein (a) comprises resetting the timer of the frequency field when the performance monitoring packet is transmitted to the sink LSR.

8. The method of claim 5, wherein (a) comprises when a performance monitoring end request is input from the outside, terminating the timer of the frequency field and ceasing transmitting performance monitoring packets to the sink LSR.

9. The method of claim 5, wherein (c) comprises calculating the packet loss by subtracting a difference (C−D) between a packet counter value (C) after the sink LSR receives the data packets and a packet counter value (D) before the sink LSR receives the data packets, from a difference (A−B) between a value (A) of the transmission counter field and a packet counter value (B) before the source LSR transmits the data packets.

10. The method of claim 9, wherein (c) comprises after the calculation of the packet loss, storing the value (A) of the transmission counter field as a packet counter value of the source LSR and storing the packet counter value (C) after the sink LSR receives the data packets, as a packet counter value of the sink LSR.

11. The method of claim 5, wherein (d) comprises when clock synchronization is made between the source LSR and the sink LSR, calculating packet transfer delay time of the performance monitoring packet.

12. The method of claim 5, wherein (d) comprises calculating packet transfer delay time, and then calculating packet jitter based on deviation of the packet transfer delay time.

13. The method of claim 5, wherein the performance monitoring packet is an OAM packet or a separate packet comprised in the OAM packet.

14. An apparatus for processing packets in order to measure the performance of a Label Switch Path (LSP) set between two Label Switch Routers (LSRs) in a Multi-Protocol Label Switching (MPLS) network, the apparatus comprising:
a packet transmission processing unit transmitting a performance monitoring packet comprising at least one of a transmission counter field storing the number of data packets transmitted via a designated LSP, a time stamp field storing the time when the performance monitoring packet is transmitted, and a frequency field storing the frequency of transmission of the performance monitoring packet, together with the data packets; and
a packet reception processing unit receiving the performance monitoring packet and the data packets, and if the transmission counter field exists in the performance monitoring packet, calculating packet loss based on the value of the transmission counter field and the number of the received data packets, and if the time stamp field exists in the performance monitoring packet, calculating packet transfer delay time by subtracting the time when the performance monitoring packet is received from the value of the time stamp field.

15. The apparatus of claim 14, wherein the packet transmission processing unit transmits the performance monitoring packet to the sink LSR when a performance monitoring start request is input from the outside or when a time set in a timer of the frequency field has elapsed.

16. The apparatus of claim 14, wherein the packet transmission processing unit resets the timer of the frequency field when the performance monitoring packet is transmitted.

17. The apparatus of claim 14, wherein the packet reception processing unit, if the transmission counter field exists in the performance monitoring packet, calculates the packet loss by subtracting a difference (C−D) between a packet counter value (C) after the packet reception processing unit receives the data packets and a packet counter value (D) before the packet reception processing unit receives the data packets, from a difference (A−B) between a value (A) of the transmission counter field and a packet counter value (B) before the packet transmission processing unit transmits the data packets.

18. The apparatus of claim 17, wherein the packet reception processing unit stores the value (A) of the transmission counter field as a packet counter value of the packet transmission processing unit and stores the packet counter value (C) after the packet reception processing unit receives the data packets as a packet counter value of the packet reception processing unit, after the calculation of the packet loss.

19. The apparatus of claim 14, wherein the packet reception processing unit, if the time stamp field exists in the performance monitoring packet, calculates packet transfer delay time when clock synchronization is made between the packet transmission processing unit and the packet reception processing unit.

20. The apparatus of claim 14, wherein the packet reception processing unit calculates packet jitter based on deviation of the calculated transfer delay time.

21. The apparatus of claim 14, wherein the performance monitoring packet is an OAM packet or a separate packet comprised in the OAM packet.

22. An interface apparatus for processing Operation & Maintenance (OAM) packets regarding a Label Switch Path (LSP) set in a Multi-Protocol Label Switching (MPLS) network, the interface apparatus comprising:
a packet transceiver transmitting a plurality of data packets or OAM packets by converting an optical signal to an electrical signal;
a frame multiplexer/demultiplexer multiplexing the plurality of data packets or OAM packets, or demultiplexing multiplexed packets;
a network processor unit calculating packet loss or packet transfer delay time, based on a transmission counter field storing the number of data packets transmitted via a designated LSP or a time stamp field storing the time when an OAM packet is transmitted if a packet received from the frame multiplexer/demultiplexer is an OAM packet; and generating OAM packets, which comprise the transmission counter field and/or the time stamp field, to be transmitted to the network; and
a switch fabric interface unit transmitting a data packet to the network if a packet received from the frame multiplexer/demultiplexer is the data packet.

23. The interface apparatus of claim 22, wherein the network processor unit comprises:
a packet classifier determining whether a packet input from the frame multiplexer/demultiplexer is a data packet or an OAM packet;
an OAM packet receiver calculating packet loss based on the value of a transmission counter field and the number of data packets received by the packet transceiver if the transmission counter field exists in the OAM packet, and calculating the difference between the value of a time stamp field and the reception time of the performance monitoring packet as a packet transfer delay time if the time stamp field exists in the OAM packet;
an OAM packet transmitter generating an OAM packet comprising at least one of a transmission counter field storing the number of data packets transmitted via a designated LSP, a time stamp field storing the time when an OAM packet is transmitted and a frequency field storing the frequency of transmission of the OAM packet, and transmitting the OAM packet to the switch fabric interface unit; and
a network OAM packet processing unit providing packet assembly information related to OAM packet transmission and requesting the OAM packet transmitter to transmit an OAM packet for packet monitoring.

24. The interface apparatus of claim 23, wherein the OAM packet receiver if the transmission counter field exists in the OAM packet, calculates the packet loss by subtracting a difference (C−D) between a packet counter value (C) after a receiving end receives the data packets and a packet counter value (D) before the receiving end receives the data packets from a difference (A−B) between a value (A) of the transmission counter field and a packet counter value (B) before a transmitting end transmits the data packets.

25. The interface apparatus of claim 23, wherein the OAM packet receiver stores the value (A) of the transmission counter field as a packet counter value of the and stores the packet counter value (C) after the receiving end receives the data packets as a packet counter value of the receiving end, after the calculation of the packet loss.

26. The interface apparatus of claim 23, wherein the OAM packet receiver calculates packet jitter of the OAM packet based on deviation of the calculated packet transfer delay time.

27. The interface apparatus of claim 23, wherein the OAM packet transmitter resets a timer of the frequency field when transmitting the OAM packet to the switch fabric interface unit.

28. A recording medium for recording packet frames in order to measure the performance of a Label Switch Path (LSP) set between two Label Switch Routers (LSRs) in a Multi-Protocol Label Switching (MPLS) network, the recording medium comprising:
a transmission counter field storing the number of data packets transmitted via a designated LSP in order to calculate loss of transmitted data packets; and
a time stamp field storing the time when a performance packet is transmitted in order to calculate delay time or jitter in transmission of the data packets.

29. The recording medium of claim 28, further comprising a frequency field determining the frequency of transmission of the performance monitoring packet using a set time timer.

30. The recording medium of claim 28, further comprising at least one of a function type field indicating a function type of the performance monitoring packet, and an LSP identifier field indicating an LSP of which performance monitoring is requested.

31. The recording medium of claim 28, wherein the performance monitoring packet is an OAM packet or a separate packet comprised in the OAM packet.
